(19) United States
(12) Patent Application Publication
(10) Pub. No.: US 2021/0334287 A1
(43) Pub. Date: Oct. 28, 2021

(54) HIGHSY-PERSPECTIVE ENGINE

(71) Applicant: Phillip Fayne, Chicago, IL (US)

(72) Inventor: Phillip Fayne, Chicago, IL (US)

(21) Appl. No.: 17/241,415

(22) Filed: Apr. 27, 2021

Related U.S. Application Data
(60) Provisional application No. 63/016,739, filed on Apr. 28, 2020.

(51) Int. Cl. G06F 16/2457; G06F 16/9535

(52) U.S. Cl. CPC G06F 16/24578; G06F 16/9535

(57) ABSTRACT

A method includes a device receiving registration information indicating a demographic perspective that includes cultural and social values. A processor within the device searches for a series of potential options based on the registration information. The processor also searches for the potential options based on an initial set of fixed values, a changing set of values, and a hybrid set of values. The device compares the series of potential options based on the initial set of values, changing set of values, hybrid set of values, and demographic perspective. The device also appraises the series of options, wherein the device performs an ordering and/or ranking of the potential options. The device also identifies an optimal fit based on the ordering and/or ranking of the potential options.

### CROSS-REFERENCE TO RELATED APPLICATIONS

This application claims the benefit of U.S. Provisional Patent Application No. 63/016,739 filed on Apr. 28, 2020, being fully incorporated herein by reference.

### BACKGROUND

### Field of the Art

Embodiments of the present invention described herein generally relate to deploying artificial intelligence (AI) and fixed, non-fixed, hybrid values, and demographic perspectives to obtain one or more optimal results that can be used to ultimately determine an aggregate score for an entire community.

### Discussion of the State of the Art

Currently, when attempting to make decisions and/or purchase products, consumers may often rely on market definitions and perspectives when making those decisions and purchases. If any personal values that are factored into such decisions and purchases, those values often may come from a fixed set of data or values. The personal values are taken from a fixed time and remain unchanged. Any predictions on what purchases and decisions that a user may make based on personal values depend on a fixed set of personal values, and not a dynamic set of personal values.

When using a fixed set of data/values to make predictions on decisions and purchases that a user may make, the predictions may often be unable to account for any changes in the personal values of the user/consumer. As such, the predictions may simply predict what the user/consumer will decide or purchase based on a static set of personal values. As a result, an endpoint decision or purchase can be made or had based on the assumption that the user still had the exact same personal values as when the prediction was first made. As such, the product or decision may not align with the user's current personal perspective values that may have evolved.

Accordingly, a need exists for a system that can enable a user to make decisions and purchases that also account for the personal perspective values of the user that can evolve over time. Moreover, the current personal perspective values of a user can change over time wherein the user redistributes his values to other values, or where the user adds additional values within his personal perspective values. Further, there is a need for a system that identifies the origin and basis for the user's personal perspective values, such as for example, the user's social circles, socioeconomic background, race, and gender. Accordingly, a system that can enable a user to make decisions and purchases based on a dynamic set of personal perspective values that are constantly changing can enable users to identify decisions and purchases that most align with their current personal perspective values.

### SUMMARY

The present invention overcomes the limitations described above by introducing a method for enabling a user to determine an optimal fit from a series of options.

In an embodiment, a method includes receiving, by a device, registration information required to make one or more selections, the registration information indicating a demographic perspective, wherein the demographic perspective includes cultural and social values. The method also includes searching, by a processor configured within the device, for a series of potential options that can be chosen and/or selected for use. The processor searches for the potential options based on a fixed set values, a changing set of values, and a hybrid set of values.

The processor searches for the potential options based on an additional set of values that acquired at a later interval, and searches for the potential options based on a hybrid set of values. The method also includes comparing, by the device, a series of the potential options found from the search, the comparison of the series of the potential options being based on the perspective specific search of the initial set of values, the changing set of values, the hybrid set of values, and the demographic perspective. In addition, the method also includes appraising, by the device, an ordering and/or ranking for the series of potential options, the ordering and/or ranking based on the comparison of the potential options based on the fixed set of values, changing set of values, hybrid set of values, and demographic perspective. Further, the method includes

In an embodiment of the disclosure, the search for the series of potential options is based on the cultural values with respect to race/ethnicity.

In an embodiment of the disclosure, the cultural values remain fixed over time.

In an embodiment, a method includes inputting into one or more mobile devices, registration values including cultural and social values. The method also includes searching, by a processor configured into the one or more mobile devices, for information based on the cultural and social values, wherein the searching is based on the cultural values and social values, a fixed set of values, a changing set of values, and a hybrid set of values. The processor locates the information based on the cultural and social values, the fixed set of values, the changing set of values, and the hybrid set of values. The method also includes ranking, by the one or more mobile devices, a list of options based on the social and cultural values, the fixed set of values, the changing set of values, and the hybrid set of values. Further, the method includes determining, by the one or more mobile devices, optimal results based on the ranking of the list of options based on the social and cultural values, the fixed set of values, the changing set of values, and the hybrid set of values.

In an embodiment of the disclosure, the one or more mobile devices compare the list of options based on the social and cultural values, the fixed set of values, the changing set of values, and the hybrid set of values.

In an embodiment of the disclosure, the set of values that change over time intervals change in response to a purchase of a new home.

In an embodiment of the system, the system includes a mobile or computing device configured to receive registration information required to make one or more selections, the registration information indicating a demographic perspective, wherein the demographic perspective includes cultural and social values. The system also includes a processor configured within the device. The processor is configured to search for a series of potential options that can be chosen and/or selected for use, the search for the potential options being perspective specific and based on the registration information indicating the demographic perspective that include the cultural and social values. The processor also searches for the potential options based on a fixed set of values, and a changing set of values, and a hybrid set of values. Further, the system includes a comparator coupled to the processor and configured within the device. The comparator is configured to compare a series of the potential options found from the search. The comparison of the series of the potential options is based on the demographic perspective, the fixed set of values, the changing set of values, and the hybrid set of values. The system also includes an appraiser configured within the device and coupled to the comparator. The appraiser configured to appraise an ordering and/or ranking for the series of potential options. The ordering and/or ranking is based on the demographic perspective, fixed set of values, changing set of values, and the hybrid set of values. In addition, the system includes an identifier configured within the device and coupled to the appraiser, and configured to identify an optimal fit based on the ordering and/or ranking of the potential options.

In an embodiment of the disclosure, one or more of the changing set of values are configured to change on an annual basis.

In an embodiment of the disclosure, the hybrid set of values combine an additional fixed set of values and an additional changing set of values acquired at the later time interval.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an overview figure of a computing device with respect to an embodiment of the present disclosure;

FIG. 2 illustrates a block diagram of an aspect of the present invention.

FIG. 3 illustrates another block diagram of an aspect of the present invention.

FIG. 4 illustrates a block diagram with respect to an embodiment of the invention.

FIG. 5 illustrates a block diagram of an embodiment of the invention.

FIG. 6 illustrates a flowchart with respect to an embodiment of the invention.

### DETAILED DESCRIPTION

The present invention is for applying non-fixed personal perspective definitions with artificial intelligence machine learning in a computing device or computing system.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The present disclosure shows the advantages of athletes, buyers, and individuals attempting to obtain a list of colleges to attend based on a fixed set of initial values, a set of values that change over time, and a hybrid set of values that combine the fixed set of initial values and the set of values that change over time. Moreover individuals can use the fixed values, changing values, and hybrid values to purchase a home or a new car.

The fixed set of initial values can include, but are not limited to, location preference, proximity to family and friends, and brand name recognition. When selecting a school or buying a home, where the school or home is located, and how close it is to family can be fixed values which athletes and/or buyers will have that are not likely to change over time. The brand name recognition of a school or a car can also be a fixed value that is not likely to change for a student or buyer.

As mentioned above, the set of values that change over time can include, but are not limited to, the desire to play closer to home, the desire to play at a university that has a certain major, a university that graduates all of its players, and other values which the student-athlete can acquire over time. The changing set of values can also include, but are not limited to, whether buyers wish to buy homes closer to or farther from friends and relatives, and the amenities that a home may have (the size of a garage, the number of rooms). Further, with respect to buyers and cars, the changing set of values can include, but are not limited to, the color of the car, the brand of the car, and the amenities of the car. The changing values are values that are likely to change at later time intervals. The later time intervals can be on an annual basis or semi-annual basis as an example. The changing values can also change at any time for the user.

The hybrid set of values can include, but are not limited to, one or more of the fixed values that have evolved into changing values, and one or more of the changing values that have evolved to fixed values. Further, the hybrid set of values can include, but are not limited to, one or more new fixed values and one or more new changing values. The hybrid set of values can also apply to student-athletes, and buyers/purchasers of homes, cars etc. Such hybrid values can include where the student-athlete's fixed value of playing close to home becomes a changing value, where the student-athlete value does not value playing close to home. A home buyer similarly may decide that buying a home close to family and relatives can change over time, and not be a fixed value. Further, a car buyer may originally have a fixed value of buying a car of a certain make and model, but may then decide that other makes and model cars are just as suitable, and later view this value as a changing value. The changing values of the student-athletes and buyers can later become fixed values. Such changing values of not needing a car of a certain color, or a home in the suburbs, or a college with engineering degrees can later become fixed values. A student-athlete may decide that a college has to have an engineering major. A buyer may decide that a home has to be in the city or a car needs to have certain specific amenities such as a sunroof.

The fixed values, changing values, and hybrid values described above can be unique to each student-athlete and buyer. What each student-athlete or buyer values among vary in virtually each situation. The fixed values, changing values, and hybrid values can be used to obtain one or more optimal/desired results for student-athletes and buyers.

The athlete or buyer can use the fixed values, changing values, and hybrid values onto a smart search engine (Highsy) to obtain one or more optimal fits based on those values. Highsy can provide the desired and optimal fits on one or more mobile devices of the athlete's and/or buyer's choice.

In addition, the demographic perspective of the user can be applied. The demographic perspective can include the user's social and cultural values. The community that the user is or has been a part of can shape the user's social and cultural values. The user's community can be, but is not limited to, the racial/ethnic community of the user.

Highsy can assign a score to the user based on the user's optimal fit(s). Further, Highsy can also assign a score based on the optimal fit(s) to other users in the same community. Highsy can also aggregate all of the scores of the users in that community, and determine an aggregate score for that community. As mentioned above, the community can be, but is not limited to, the racial/ethnic of the users. As such, based on the optimal fit(s), Highsy can determine an aggregate score for an entire community.

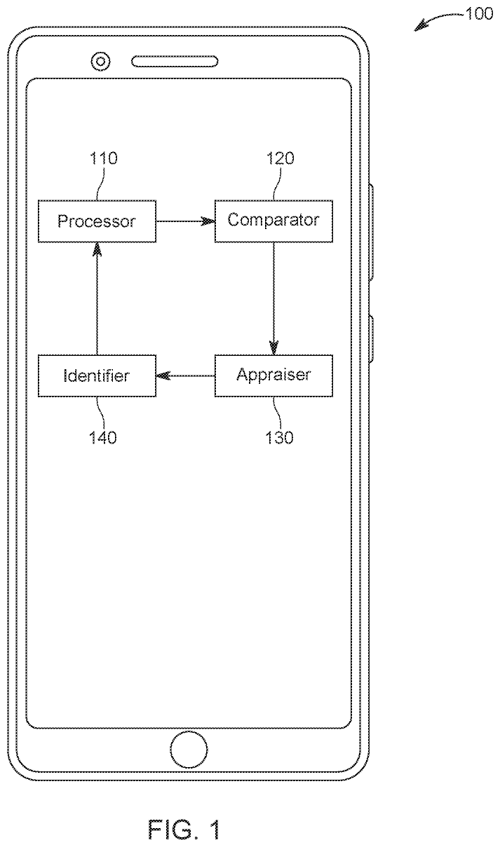

Referring to FIG. 1 (FIG. 1,) a device 100 is shown that can enable a student-athlete and or buyer input information such as the fixed values, changing values, and hybrid values to obtain optimal/desired results accordingly using Highsy. The device can be a mobile phone, desktop, or laptop computer. The device 100 includes a processor 110, a comparator 120, an appraiser 130, and an identifier 140.

In FIG. 1, a user (such as a student-athlete, buyer) logs onto the device 100. When logged in, the user provides registration information to the device 100. The user provides the registration information to make one or more selections. The registration information will include the demographic perspective of the user. The demographic perspective will include cultural and social values of the user. The cultural and social values of the user can be based on the race and ethnicity of the user. Further, the cultural and social values can also be due to the environment that the user was a part of. Such environments can include urban environments in non-traditional family settings. The cultural values and social values can be a part of the fixed values, changing values, and hybrid values described above. In addition, the optimal fit for the user based on the fixed values, changing values, and hybrid values can be used as a score for the community in which the user belongs. The user's score can be used as part of an aggregate of the other scores within the user's community with regard to picking a school to attend, or a purchase to make (home, car, etc.).

In FIG. 1, a user device 100 (such as a mobile device, desktop computer) going through the process of registration, searching, comparing, appraisal, and optimal fit is demonstrated. The user may register within the user device 100 to attempt to purchase a home, car, or to select a university to attend. The user may enter his/her registration information. Such information can include the demographics of the user. The demographics will include the racial/ethnic community that the user identifies with. As such, the user may indicate his/her race, socioeconomic background, current city, and gender as examples. The user may also input his/her connections. The connections can be people that the user may know in relation to homes, cars, and universities. The user may also enter his/her social circles that he/she may be a part of. As such, the user can input his social and cultural values. The social and cultural values can include the user's personal perspective values. The personal perspective values can be values (fixed, changing, and hybrid) that the user holds when determining what to buy or what school to attend to buy. Accordingly, the user will enter registration information on the user device 100 that includes cultural and social values.

In FIG. 1, the user can perform a search of the laptop, home, car or university on the user device 100 based on his/her registration information. A processor 110 configured within the user device 100 can enable the search to be performed. The processor 110 can enable the search engine Highsy to perform the search. Highsy searches for the potential options (laptop, home, car, university) based on an initial set of values of the user. The initial set can be based on the user's fixed set of values. The fixed set of values are values that are not likely to change at a later time. Highsy can also search for the home, laptop, car, or university based on a changing set of values. The changing set of values is values that the user has that are likely to evolve and change over time. Such values can include having a value of wanting to buy a car of a make and model, but not necessarily having to have a car of that particular make and model. Highsy can search for the home, car, laptop, or university based on a hybrid set of values. The hybrid set of values include fixed values that have become changing values, and changing values that have become fixed values. For instance, the user can have a fixed value of wanting to attend a university close to relatives. Nevertheless, after some searching has taken place, the user can decide that it would be okay to search for universities that are not close to relatives. As such, the fixed value can become a changing value. In another example, a user can have a changing value of wanting to find a house or apartment, but then while searching, determine that the search should be limited to houses and not include apartments. As such, the changing value of wanting a house or apartment has become a fixed value of wanting to find a house. The hybrid set of values can also include new fixed values and new changing values which the user has newly acquired.

In FIG. 1, a comparator 120, configured within the user device 100, can enable the search engine Highsy to compare the results found based on the fixed values, changing values, and hybrid values of the user. Moreover, Highsy can compare the found results based on the demographic perspective of the user. As such, Highsy compares the results according to the user's fixed values, changing values, hybrid values, and demographic perspective. Based on the comparison of the results, an ordering and ranking of the results can be determined.

Referring to FIG. 1, as Highsy has made a comparison based on the search results found based on the fixed values, changing values, hybrid values, and demographic perspective, a ranking or ordering of the search results can occur. An appraiser 130 configured within the user device 100 and coupled to the comparator 120 can enable the search engine Highsy to appraise an order/ranking of the search results. Based on the user's fixed values, changing values, hybrid values, and demographic perspective, the search results can be ranked accordingly. Given that each user will likely have different fixed values, changing values, hybrid values, and demographic perspective, the ranking/ordering would likely be different for each user. As the search results are arranged in a ranking/order based on the user's fixed values, changing values, hybrid values, and demographic perspective, Highsy can then identify the optimal fit. Moreover, Highsy can identify the optimal laptop, home, or car to purchase based on the user's fixed values, changing values, hybrid values, and demographic perspective. Further, Highsy can identify what college to attend based on the fixed values, changing values, hybrid values, and demographic perspective.

In FIG. 1, as an order/ranking of the search results has taken place, an identifier 140 configured within the user device 100 can enable the search engine Highsy to identify the optimal fit among the ordered search results. As each user will have different fixed values, changing values, hybrid values, and demographic perspective, the optimal fit for each user can be different. Further, the user will not be limited necessarily to one optimal fit for a laptop, home, car, or university. In many instances, Highsy can identify one or more optimal fits based on the user's fixed values, changing values, hybrid values, and demographic perspective.

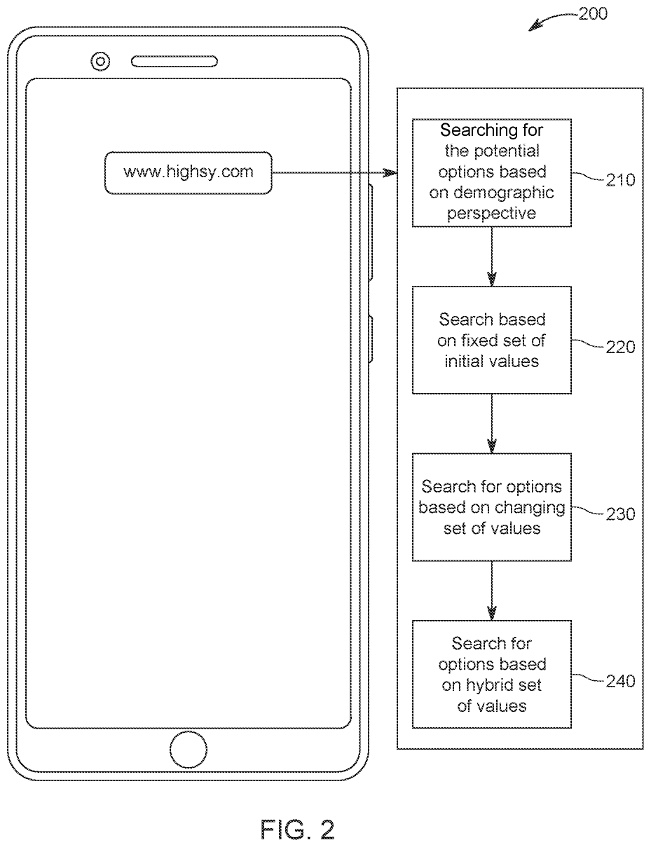

FIG. 2 illustrates a user device 200 shown with a corresponding search engine Highsy. The user device can be any know mobile device or desktop computer. As the user has inputted the prospective searches onto the search engine Highsy, the user has inputted the prospective searches based on the user's fixed values, changing values, hybrid values, and demographic perspective. Highsy searches for the potential options based on the user's demographic perspective 210. The user's demographic perspective can include the user's social and cultural values. The user's social and cultural values can include, but are not limited to, views on race, culture, education, and politics that are influenced by the neighborhood, community, and race that the user belongs to. A user determining what home, car, or laptop to buy, or what university to attend, will input searches into Highsy that correspond to the user's social and cultural values.

Referring to FIG. 2, the user can also input the search options onto Highsy based on a fixed set of values. The fixed set of values can be the user's values that are likely to remain constant and not change over time. The search can be conducted on Highsy based on the user's fixed set of values 220. Depending on whether the user wishes to buy a home, car, laptop, or select a university to attend, the user can have a fixed set of values that correspond to the searches inputted into Highsy. For instance, the user can have fixed values such as a car or/laptop have to be of a specific color and made from a particular brand name. With respect to a home, the user may require that the home be located in a suburban community and have at least four bedrooms. In relation to a university, the user can have a fixed value of where the university has have a particular basketball coach and has to be located in his/her home state. As such, the user can input the search options that are also based on his/her fixed values.

In FIG. 2, the search will also include the user inputting search options onto Highsy based on an additional or changing set of values 230. The changing set of values can be values that are more than likely to change at a later time. The user can have a changing set of values that change annually or quarterly or at random time intervals. Unlike the fixed values, the user can have a set of values that the user knows can change in the future. For instance, with respect to a home or a car, the user can at that time interval have a value that the house should sold from a specific realtor or car that is a sports car. Nevertheless, the user is aware that he/she may change their mind on these values at a later time interval. With respect to choosing a university, the user, at a certain time, may desire a university that has a student body greater than ten thousand students. However, the user is aware that he/she may change his mind on the size of the student body at a later date. As such, the changing values are values which the user has a particular time, but is likely to change at a later time.

With respect to FIG. 2, the user can input search options into Highsy based on a hybrid set of values 240. The user can have a hybrid set of values in addition to the fixed values and changing values described above. The hybrid set of values can include fixed values that evolved to changing values, and changing values that evolved to fixed values. For instance with respect to purchasing a laptop, the user may at prior time interval have had a fixed value of requiring the laptop to be from a company (Apple), but a later time interval, the user does not only prefer laptops from a particular brand (Apple), but also from other brands as well (Microsoft). Further, with school selections, at a prior interval, the user may have had a changing value in which originally, the user was not set on a school having specific major (art, engineering). However, at a later time interval, the changing value has become a fixed value wherein the university has to have an art/engineering major for the user to consider the university among the search options. In addition, as stated above, the hybrid values can include additional fixed values and changing values that the user has acquired at a later time interval.

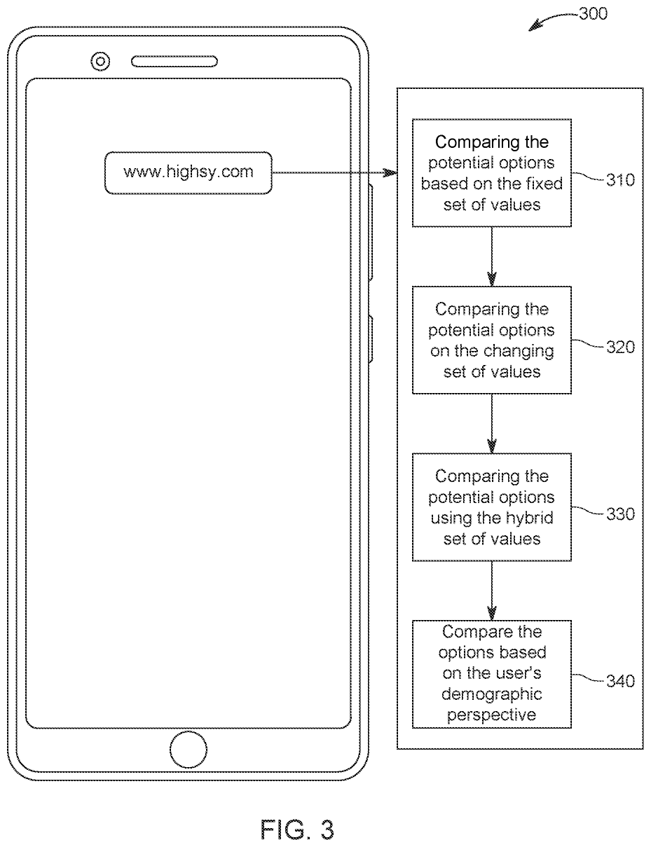

In FIG. 3, a user device 300 is shown to illustrate the comparison of the search options. The user device 300 can be any mobile device (iPhone, tablet) or desktop computer. Due to the search performed on Highsy, the search engine, has a list of options have been found during the search. The search was based on the user's fixed values, changing values, hybrid values, and demographic perspective. The search results are thereby based on the fixed values, changing values, hybrid values, and demographic perspective of the user. As such, the comparison of the search results will be based on the fixed values, changing values, hybrid values, and demographic perspective of the user.

In FIG. 3, the search options are compared based on the initial set of values 310 of the users. The initial set of values are the user's fixed values. The fixed values are the values which are not likely to change over time, and which are required to be a part of the search options. For the potential purchase of a home or laptop, the user can have a fixed value that the home has to have a certain minimum square footage, and the laptop has to have a minimum memory. In regard to selecting a university, the user can require that the university has to be a state/public university.

Referring to FIG. 3, the comparison of the search results based on the changing values 320 occurs. The changing values are the user's values that the user is aware are bound to change at a later time. With respect to a home purchase, the user at the time may want to purchase a home in the suburbs, but at a later time interval, the user may want to purchase a home in the city. With respect to selecting a university, the user may presently want to attend a university in warm weather state, but at a later time, the user may want to attend a university in a cold weather state. As such, the comparison of the search results by Highsy are also based on the user's changing values.

In FIG. 3, the comparison of the search results are also based on the user's hybrid values 330. The user's hybrid values include the fixed values that have become changing values, and the changing values that have become fixed values. During the process, when attempting to purchase a car, the user may have originally had a fixed value of the car being from a specific company. However, the user may have this fixed value being a changing value, where the car can be from other companies as well. When trying to select a university, the user, at an earlier interval, can have a changing value where a university does not have to have engineering majors. Nevertheless, at a later interval, when attempting to select a university, the university having engineering majors can become a fixed value. As such, the previous changing value has become a fixed value at the later interval. In addition, the hybrid values can also include new fixed values and new changing values that the user acquired at a later interval.

Referring to FIG. 3, the comparison of the search results by Highsy also takes into account the demographic perspective 340 of the user. Moreover, the social and cultural values of the user are factored into the comparison of the search results. The social and cultural values of the user can be based on, but are not limited to, the demographic group and environment that the user has been a part of.

Once the search results have been compared based on the fixed values, changing values, hybrid values, and demographic perspective, a ranking and ordering based on these factors can occur.

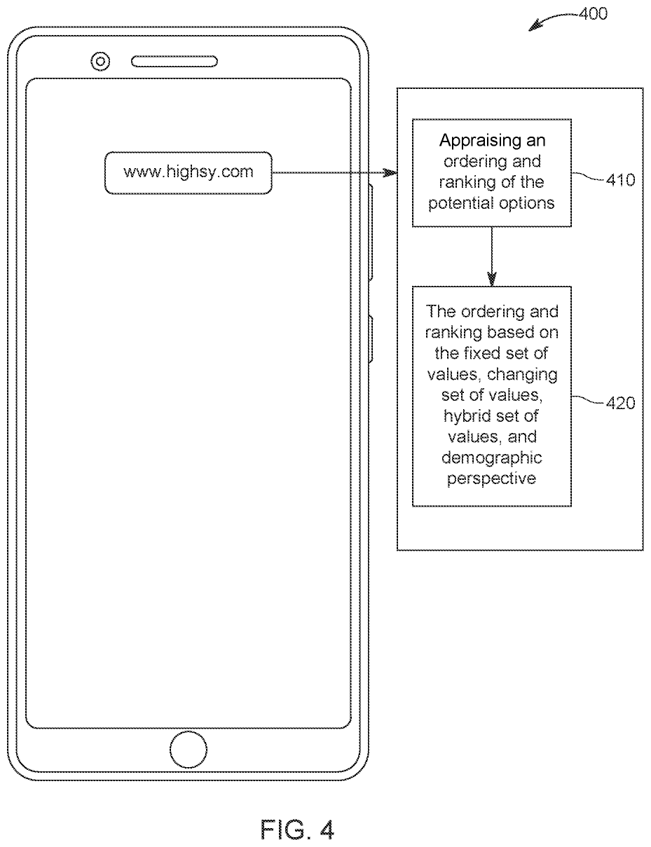

Referring to FIG. 4, another user device 400 is illustrated. As in the embodiments described above, the user device 400 can be a typical mobile device such as an IPhone, tablet, or a desktop computer. After Highsy has found the search results, and compared the search results based on the user's fixed values, changing values, hybrid values, and demographic perspective, the search results based on these values and demographic perspective can be appraised/ranked accordingly.

In FIG. 4, the search engine Highsy can also appraise a ranking/ordering of the search results based on the user's fixed values, changing values, hybrid values, and demographic perspective. An ordering/ranking 410 of the potential search listings is performed. As such, the search options that are more in line or correspond with the user's fixed values, changing values, hybrid values, and demographic perspective will be ranked above the search listings that are not as correlated to the user's values and demographic perspective. Accordingly, the ordering and ranking by Highsy based on the user's values and demographic perspective 420 is illustrated.

In FIG. 4, the search listings that most correlate the user's fixed values with regard to buying a home, car, or other purchase, or selecting a university are more likely to be ranked near the top of the ordering/ranking of the search listings. The fixed values will be what the user will always likely value when making a purchase or selecting a university. The search listings that more correlate to the user's changing values will also be more likely to appear at the top of the ordering/ranking. The changing values will be values that the user has the present time, but is subject to change at a later time interval. Further, the search listings that correspond more to the user's hybrid set of values will also be more likely to be ranked above the search listings that do not correspond as closely to the user's hybrid set of values. The hybrid set of values will be changing values that originally were fixed values, and fixed values that were originally changing values. The hybrid set of values also include new fixed values and new changing values that the user acquired after beginning the search for the optimal purchase or university to attend. In addition, the search listings that correspond to the user's demographic perspective will also be ranked ahead of the search listings that do not correspond as closely to the user's demographic perspective. As mentioned above, the user's demographic perspective includes the user's social and cultural values that the user wants to have represented within the search listings. As such, the search listings that are more aligned with the user's social and cultural values will be ranked above the search listings that are not as closely aligned with the user's social and cultural values.

The search listings from the search for the home, car, laptop, or university are searched for and compared based on the user's fixed values, changing values, hybrid values, and demographic perspective. The search listings are also ordered/ranked based on the user's values and demographic perspective. After the search listings have been ordered/ranked, Highsy can determine an optimal fit, or one or more optimal fits based on the ordering/ranking of the options mentioned above.

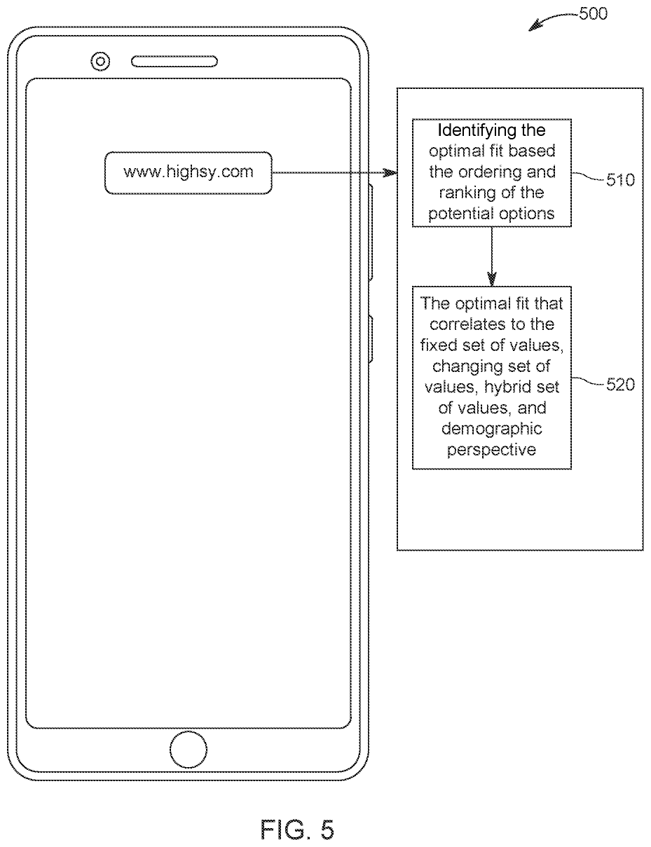

In FIG. 5, another user device 500 such as a tablet, smartphone, or desktop computer is illustrated. The search engine Highsy can be accessed by the user device 500. Once the options described above in FIG. 4 have been ranked/ordered, the search engine Highsy can identify an optimal fit 510 for the user. In other embodiments, Highsy can identify more than one optimal fit. The search engine Highsy can identify an optimal fit, whether it is a purchase (car, home, laptop, for example), or a university selection. Highsy can identify the optimal fit based on the values and demographic perspective 520. In other words, Highsy can identify the optimal fit that most correlates with the user's fixed values, changing values, hybrid values and demographic perspective. The search engine Highsy can identify the list of options that are ranked at or near the top of the ordering discussed with respect to FIG. 4, and thereby identify one or more optimal fits with the user. The optimal fit will be the ideal fit (purchase such as a car/home or a university to attend) for the user given the user's demographic perspective, fixed values, changing values, and hybrid values.

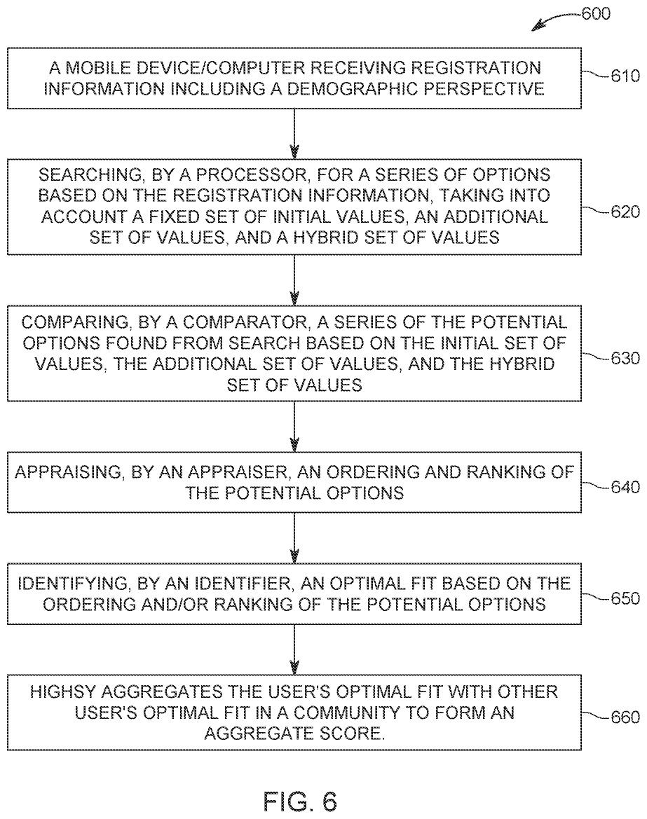

FIG. 6 illustrates, a process 600 where a user can obtain one or more optimal fits from Highsy for a purchase (house, car, laptop, etc.) or university to attend. The one or more optimal fits can be based on the user's demographic perspective (social and cultural values), fixed values, changing values, and hybrid values. Moreover, the one or more optimal fits for the user can be used by Highsy to be aggregated with other users who are in the same community. Highsy will assign a score to each user within the same community with an optimal fit(s). As a result, Highsy can aggregate the scores among the users in the same community, and determine an aggregate score for that community based on the optimal fits that have been determined for the users within that same community.

Referring to FIG. 6, at step 610, a mobile device such as an iPhone or tablet, or a desktop computer receives registration information. A user logs onto the mobile device or computer and inputs the registration information. The registration information includes the user's demographic perspective. The demographic perspective is made up of the user's social and cultural values. The user's social and cultural values can be, but are not limited to, the user's views on society and culture based on the ethnic community that the user belongs to, the neighborhood that the user was a part of, and other social and cultural values that the user identifies as being important.

In FIG. 6, at step 620, a search is performed by Highsy using the demographic information that the user inputted. Moreover, Highsy can perform the search based on the demographic information, and also use the user's fixed values, changing values, and hybrid values. The fixed values include the constant values that the user will likely always have when making a purchase or selecting a university to attend. The changing values are the values that the user can have at a present time interval, but which is subject to change at a later time interval. The hybrid values include fixed values that have become changing values, and changing values that have become fixed values. The hybrid values can also include new fixed values and new hybrid values that the user has acquired at a later time interval. A processor configured within the user device can enable the search to be performed based on the demographic perspective, fixed values, changing values, and hybrid values.

In FIG. 6 at step 630, the search engine Highsy has a list of potential options from the search performed in step 620. From the options, Highsy can compare the options based on the user's demographic perspective (social and cultural values), fixed values, changing values, and hybrid values. A comparator can be configured within the user device to enable the comparison of the potential options to be performed.

In FIG. 6, at step 640, Highsy can appraise the list of options. After the list of potential options are compared based on the user's demographic perspective, fixed values, changing values, and hybrid values, Highsy can appraise/order the list of options. The one or more options which closely correlate to the user's values and demographic perspective can be ordered/ranked ahead of the one or more options that do not correspond as closely to the user's values (fixed, changing, hybrid) and demographic perspective. An appraiser is configured within the user device to enable an order/ranking of the potential options to occur.

In FIG. 6, at step 650, after the list of options have been ranked, Highsy can determine the optimal fit. In other embodiments, Highsy can determine multiple optimal fits for the user. Highsy will identify one or more list of options according to the ordering described in step 640. As a result, Highsy will provide the user with one or more optimal fits based on the process of searching, comparing, and appraising the listed options. An identifier will be configured within the user device to enable the optimal fit or a plurality of optimal fits to be identified based on the appraisal of the list of options.

In FIG. 6 at step 660, Highsy can aggregate the user's optimal fit with other users within the user's community. Moreover, Highsy can aggregate the user's optimal fit(s) with the optimal fit(s) of other users in the user's community. The user's community can be, but is not limited to, the ethnic/racial community of the user. The user's optimal fit(s) can be assigned a score, and aggregated with the scores assigned to the other users in the same community. As such, Highsy can determine an aggregate score for the entire community based on the scores of each user in the community. The processor configured within the user device can enable the aggregate score to be determined for the community.

In summary, an optimal fit(s) can be found for a user looking to make a purchase of a home, car, laptop, etc. Further, an optimal fit can be found for the user looking to attend a university. The optimal fits can be found based on the user's demographic perspective, which include the user's social and cultural values. The optimal fit can also be found based on the user's fixed values, changing values, and hybrid values. The fixed values are values that are likely to remain constant and not change over time. The changing values are values that are likely to change over time. The hybrid values include fixed values derived from changing values, and changing values that were derived from fixed values. Further, the hybrid values also include additional fixed values and changing values that have been newly acquired at a later interval.

The search engine Highsy can search for the potential options based on the demographic perspective and values (fixed, changing, and hybrid) of the user. The Highsy can also compare the options from the search, and provide an order for the search options as well. The options which correspond more to the user's values (fixed, changing, and hybrid) and demographic perspective are ranked ahead of the options that do not correspond as closely with the user's values and demographic perspective. From the ranking of the options, Highsy can identify one or more optimal fits for the user.

As Highsy identifies the one or more optimal fits for the user, Highsy can provide the user with a score based on the one or more optimal fits. In addition, Highsy can aggregate the user's score with other users scores that are in the same community as the user. The same community can be, but is not limited to, the same racial/ethnic community as the user. From the aggregation of the scores of each user in the same community, Highsy can determine an aggregate score for that entire community.

While exemplary embodiments are described herein, it is not intended that these embodiments describe all possible forms of the invention. Rather, the words used in the specification are words of description rather than limitation, and it is understood that various changes may be made without departing from the scope of the invention. Additionally, the features of various implementing embodiments may be combined to form further embodiments of the invention.

### Hardware Architecture

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A method comprising:
receiving, by a device, registration information required to make one or more selections, the registration information indicating a demographic perspective, wherein the demographic perspective includes cultural and social values;
searching, by a processor configured within the device, for a series of potential options that can be chosen and/or selected for use, wherein the search for the potential options is perspective specific and based on the registration information indicating the demographic perspective that include the cultural and social values, and wherein the processor searches for the potential options based on an initial set of fixed values, searches for the potential options based on a changing set of values, and searches for the potential options based on a hybrid set of values;
comparing, by the device, a series of the potential options found from the search, the comparison of the series of the potential options being based on the perspective specific search of the fixed set of values, the changing set of values, the hybrid set of values, and the demographic perspective;
appraising, by the device, an ordering and/or ranking for the series of potential options, the ordering and/or ranking based on the comparison of the potential options based on the fixed set of values, changing set of values, hybrid set of values, and demographic perspective; and
identifying, by the device, an optimal fit based on the ordering and/or ranking of the potential options.

2. The method of claim 1, wherein the search for the series of potential options is based on the cultural values that are constant at one or more time intervals.

3. The method of claim 1, wherein an aggregate score for a community is determined.

4. The method of claim 1, wherein one or more of the options aligned with the changing values are ranked above the one or more options that are not aligned with the changing values.

5. The method of claim 1, wherein the social values include a collection of values that are not constant over one or more time intervals.

6. The method of claim 1, further comprising:
searching for the series of potential options based on the hybrid values acquiring additional fixed values.

7. The method of claim 1, wherein the hybrid values include a combination of new fixed values and new changing values.

8. A method comprising:
inputting into one or more mobile devices, registration values including cultural and social values;
searching, by a processor configured into the one or more mobile devices, for information based on the cultural and social values, wherein the searching is based on the cultural values and social values, and a fixed set of values, a changing set of values, and a hybrid set of values, and wherein the processor locates the information based on the cultural and social values, the fixed set of values, the changing set of values, and the hybrid set of values;
ranking, by the one or more mobile devices, a list of options based on the social and cultural values, the fixed set of values, the changing set of values, and the hybrid set of values; and
determining, by the one or more mobile devices, optimal results based on the ranking of the list of options based on the social and cultural values, the fixed set of values, the changing set of values, and the hybrid set of values.

9. The method according to claim 8, further comprising:
comparing, by the one or more mobile devices, the list of options based on the social and cultural values, the fixed set of values, the changing set of values, and the hybrid set of values.

10. The method according to claim 8, wherein the fixed set of values remain constant in response to an enrollment in a new university.

11. The method according to claim 8, wherein the changing set of values that change over time intervals change in response to a purchase of a new home.

12. The method according to claim 8, wherein the fixed set of values are configured to have different values from the changing set of values.

13. The method according to claim 8, wherein an aggregate score is determined for one or more communities.

14. The method according to claim 8, wherein the hybrid set of values are configured to include an additional fixed set of values and an additional changing set of values.

15. A system comprising:
a mobile or computing device configured to receive registration information required to make one or more selections, the registration information indicating a demographic perspective, wherein the demographic perspective includes cultural and social values;
a processor configured within the device, and configured to search for a series of potential options that can be chosen and/or selected for use, the search for the potential options being perspective specific and based on the registration information indicating the demographic perspective that include the cultural and social values, wherein the processor also searches for the potential options based on a fixed set of values, and a changing set of values, and a hybrid set of values; and
a comparator coupled to the processor and configured within the device, and configured to compare a series of the potential options found from the search, the comparison of the series of the potential options being based on the demographic perspective, the fixed set of values, the changing set of values, and the hybrid set of values;
an appraiser configured within the device and coupled to the comparator, and configured to appraise an ordering and/or ranking for the series of potential options, the ordering and/or ranking based on the demographic perspective, fixed set of values, changing set of values, and the hybrid set of values; and
an identifier configured within the device and coupled to the appraiser, and configured to identify an optimal fit based on the ordering and/or ranking of the potential options.

16. The system of claim 15, wherein one or more of the changing set of values are configured to change on an annual basis.

17. The system of claim 15, wherein the hybrid set of values combine an additional fixed set of values and an additional changing set of values acquired at a later time interval.

18. The system of claim 15, wherein the appraiser ranks the potential options that correlate with the fixed values and hybrid values ahead of the potential options that have less correlation to the fixed values and hybrid values.

19. The system of claim 15, wherein aggregate score for a community is determined based on the optimal fit.

20. The system of claim 15, wherein the changing set of values are greater than the fixed set of values.
